(19) United States
(12) Patent Application Publication
(10) Pub. No.: US 2007/0194642 A1
(43) Pub. Date: Aug. 23, 2007

(54) Eccentric rotor and flat motor comprising same

(76) Inventors: Tadao Yamaguchi, Isesaki-shi (JP); Katsuhito Sohara, Isesaki-shi (JP)

Correspondence Address: JORDAN AND HAMBURG LLP, 122 EAST 42ND STREET, SUITE 4000, NEW YORK, NY, 10168, US

(21) Appl. No.: 11/528,731

(22) Filed: Sep. 27, 2006

(30) Foreign Application Priority Data
Feb. 23, 2006 (JP) 2006-047164
Apr. 28, 2006 (JP) 2006-125942

(51) Int. Cl. H02K 7/06; H02K 7/10

(52) U.S. Cl. 310/81

(57) ABSTRACT

A printed wiring board includes a commutator at a rotation center thereof on one side and a bearing at the rotation center on the other side, first, second and third wound air-core coils having an effective conductor opened to the magnetic pole opening angle, and an eccentric weight comprising a main component and a supplementary part formed so as to be no thicker than the first wound air-core coil and disposed so that the main component does not protrude axially upward of the second and third wound air-core coils. The second wound air-core coil and third wound air-core coil partially overlap both sides of the first wound air-core coil implanted on the printed wiring board, so that the supplementary part of the eccentric weight and a portion of the spark quenching elements are accommodated in the axial space created on outward of both sides of the first wound air-core coil and the main component of the eccentric weight is disposed so as to be on the side opposite the first wound air-core coil across the bearing.

### BACKGROUND OF THE INVENTION

The present invention relates to a flat vibration motor used for silent call mechanism of a portable communication device, more specifically, to an improvement of an eccentric rotor serving as a main component thereof.

Conventionally, for example, as shown in FIG. 11, a known silent call mechanism for a pager and portable phone and the like includes a cylindrical DC motor M comprising a tungsten eccentric weight W on an output shaft S. Rotation of a rotor causes the eccentric weight W to rotate, generating vibration. However, with the above conventional silent call mechanism in which the eccentric weight W is added to the output shaft S, a space for rotation of the eccentric weight W needs to be considered, entailing the problem of design restrictions.

Further, recently, cylindrical DC motors with a diameter of 4mm have been used. However, even with a motor with a diameter of 4mm, the space for rotation of an eccentric weight disposed on an output shaft is only reduced to 6mm. Further, such cylindrical motor cannot be placed in a device as is, and usually requires a member for attachment. For this reason, in some devices to which a motor is to be mounted, the eccentric weight rotation space and the member for attaching a motor take up much space, inhibiting miniaturization of a portable device.

Further, the efficiency of a cylindrical motor is only 20% to 30%, raising the problem that when an attempt is made to achieve a desired vibration amount, the current consumed becomes overly large. For this reason, a flat motor is again receiving recognition, since a thickness of 3mm or less can be easily secured, and an effective conductor can be secured in a radial direction.

The applicant has proposed a flat coreless type vibration motor in Published Patent No. H8-10972, wherein an output shaft is not used, but rather, one of three rotation type armature coils, which are equidistantly disposed, is phase-shifted and disposed on the opposite side, so as to be eccentric, thereby causing a rotor itself contained in a case and bracket to be eccentric.

A motor, comprising a built-in eccentric rotor in which such three armature coils as described above are disposed on one side, is configured so that connection wires of armature coil terminals are soldered to lands provided between the air-core coils. For this reason, the smaller the motor, the smaller are the gaps between armature coils. Therefore, it is difficult to solder without damaging the armature coils.

Furthermore, with a built-in eccentric rotor comprising three armature coils disposed on one side, the reference electric opening angle of the armature coils must be set smaller than the magnetic opening angle. Additional improvement of the efficiency is desired.

Further, as described in Laid-open Japanese Patent 2001-190052, there is a motor configured such that a large and a mid-size air-core coil overlap at the same position so that space phases thereof are equal to each other, and a resistance is inserted in place of a small coil. However, because a resistance that makes no contribution to torque is inserted therein, efficiency degrades.

With a view toward improving such efficiency, the applicants, in order to take advantage of magnetic flux, proposed, in Laid-open Japanese Patent Application No. 2003-219602, an eccentric rotor comprising first, second and third air-core coils of an axial air-gap type, and having an effective conductor opened to a degree roughly equivalent to the magnetization opening angle, in which the rotor itself causes vibration at time of rotation, and wherein a commutator is disposed on the center of one side of a printed wiring board, a resin shaft holder comprising a bearing on the other end of the commutator is provided, the first and second air-core coils overlap with disposition angles displaced about 15 to 60 and the third air-core coil is disposed so as not to overlap the first and second air-core coils.

Recently, there has been strong demand for portable devices that are miniaturized and have a variety of functions, such as games. As vibration alarm units for such a portable device, vibration motors are expected to have a longer life.

For a longer life, with a DC motor comprising a rectifier in the form of a brush and commutator, a spark quenching element can be used. However, a motor having a thickness of 3 mm or less, and a diameter of 10 mm or less, for example, a diameter of 9 mm or 8 mm, generates smaller starting torque, and an eccentric rotor contained therein is also small. Inside such an eccentric rotor, an armature coil and eccentric weight are provided. However, if an attempt is made to secure space for further providing three chip-type spark quenching elements, for the purpose of prolonging life, there is hardly any space for such disposition.

Further, with a DC motor comprising a rectifier in the form of a brush and commutator having a thickness of 3 mm or less and diameter of 10 mm or less, the opening angle of the effective conductors of the armature coils must be as wide as the magnetic pole opening angle of the magnet with which they are to be combined. With such a configuration, it is even more difficult to secure a space for disposing an eccentric weight for greater vibration, and a space for disposing chip-type spark quenching elements for a longer life.

It is, therefore, an object of the present invention, to provide air-core coils such that the effective conductor thereof is opened as wide as the magnetic pole opening angle, thereby achieving higher efficiency.

It is another object of the present invention to provide an eccentric weight and spark quenching elements in a space created by configuring the air-core coils so as to overlap each other, thereby securing greater vibration and longer life.

### SUMMARY OF THE INVENTION

The above and other objects of the invention which address and solve the above problems, are achieved according to a first aspect of the present invention, by a device comprising a printed wiring board having a commutator disposed at the rotation center on one side thereof and a bearing at the rotation center on the other side. At least first and second wound air-core coils disposed around the bearing and having an effective conductor opened as wide as the magnetic pole opening angle, the first wound air-core coil are implanted on the printed wiring board, and the second wound air-core coil is provided above the first wound air-core coil, shifted so as to partly overlap the same. An eccentric weight is disposed at a position which does not overlap the second wound air-core coil, so that the main component does not protrude axially upward of the second and third axial air-core coils, wherein in an axial space outward of the first wound air-core coil created by the displacing and overlapping of the same, at least some of the other members constituting the rotor that are thinner than the first wound air-core coil are accommodated therein.

The other specific members may be chip-type spark quenching elements according to second and third aspects of the inventions, or supplementary portions of the eccentric weight.

Another specific approach for solving the problems, according to a fourth aspect of the invention, employs an eccentric rotor, wherein a second wound air-core coil is displaced at the opening angle for disposition of about 60° above the first wound air-core coil, and the third air-core coil is disposed so as not to overlap the first and second wound air-core coils.

In order that such eccentric rotors can be contained in a flat vibration motor, according to a fifth aspect of the invention, a flat vibration motor comprises an eccentric rotor, a shaft for supporting the eccentric rotor, a magnet for supplying a magnetic field to this rotor across an axial gap, brushes for supplying power to the air-core coils via the commutator, and housings accommodating the foregoing, wherein the shaft is fixed to one of the housings so as not to outwardly protrude. After the eccentric rotor is attached, the shaft is received by another of the housings, preventing radial movement.

Further, the aforementioned problems can be resolved by another eccentric rotor, according to a sixth aspect of the invention, comprising a printed wiring board having a commutator at the rotation center on one side and a bearing at the rotation center on the other side, and first, second and third wound air-core coils disposed around the bearing and having an effective conductor as wide as the magnetic pole opening angle. An eccentric weight having a supplementary part formed so as to be no thicker than the main component and the first wound air-core coil is provided so that the main component does not protrude axially upward of the second and third axial air-core coils. The wound air-core coils are constituted so that a partial overlap of the second wound air-core coil and third wound air-core coil on both sides of the first wound air-core coil implanted on the printed wiring board causes the creation of axial spaces outwardly of both sides of the first wound air-core coil; and the eccentric weight is constituted so that the main component is provided on the side opposite the first wound air-core coil via the bearing, and the supplementary part is accommodated in the axial space so as to overlap the second and third wound air-core coils in a plan view.

Yet another specific eccentric rotor, according to seventh and eighth aspects of the invention, is an eccentric rotor, wherein at least a part of the chip-type spark quenching element is accommodated in the axial space, or a part of the spark quenching element is disposed on the main component side of the eccentric weight and overlaps a part of the main component.

Further, according to a ninth aspect of the invention, connection lands are formed around the periphery on one side of the printed wiring board, and the terminals of the wound air-core coils are connected to the connection lands and coated with a resin bank part.

According to a tenth aspect of the invention, at least a part of the connection lands is formed in the axial space.

For such eccentric rotors to be contained in a motor, according to an eleventh aspect of the invention, a flat vibration motor comprises an eccentric rotor and a shaft for supporting the eccentric rotor. A magnet for supplying a magnetic field to the rotor across an axial air-gap and brushes for supplying power to the air-core coils via the commutator are provided, as well as housings having accommodated therein the same, wherein the shaft is fixed on one of the housings so as not to outwardly protrude. The attached eccentric rotor is received by the other housing, preventing radial movement thereof.

According to the first aspect of the invention, because the reference electric opening angle for the effective conductor of each air-core coil can be set as wide as the magnetic pole opening angle, the magnetic field of the magnet with which the coils will be combined can be effectively used, improving motor efficiency.

Further, a chip-type spark quenching element can be disposed in a space created by having armature coils displaced and overlapping one another, achieving longer life.

Additionally, a part of an eccentric weigh can be disposed in a space created by having armature coils displaced and overlapping one another, increasing vibration.

Yet further, connection areas for the armature coil terminals can be taken up in a space created by having armature coils displaced and overlap one another, facilitating operations of connecting coil terminals.

According to specific second and third aspects of the invention, because a part of the spark quenching element and eccentric weight can be accommodated in an axial space that when seen from a plan view is dead space, a space for disposition thereof can be secured.

Further, according to the fourth aspect of the invention, because there are three air-core coils, electricity at all times flows through two of them, generating a stable rotational torque, and enabling a spark quenching element such as a chip capacitor to be disposed in the axial gap below the second wound air-core coil, thereby achieving long life.

According to the fifth aspect of the invention, a flat vibration motor can be easily configured by the use of such eccentric rotor.

According to the sixth aspect of the invention, because there are three wound air-core coils, electricity at all times flows through two of them, generating a stable rotational torque, and for eccentric weight, because other than the main component at a position opposite the first wound air-core coil, the supplementary part can be accommodated in the axial spaces on both sides of the first air-core coil, a sufficient weight can be secured, thereby securing sufficient vibration as well.

According to the seventh and eighths aspects of the invention, because a spark quenching element such as a chip capacitor can be disposed in this space, a long life can be achieved, thereby securing the weight of the eccentric weight as well.

Further, according to the ninth aspect of the invention, the work of connecting terminals can be easily secured, and the connection parts are protected with a resin.

In addition, according to the tenth aspect of the invention, with the use of the dead space as seen in a plan view below the wound air-core coils 3B, 3C, surface area of each connection land normally disposed outward of a wound air-core coil becomes substantially unnecessary, so that the size of the eccentric weight size is not sacrificed.

According to the eleventh aspect of the invention, sufficient vibrations can be secured even with a small size, achieving a flat vibration motor having sufficient impact resistance.

In accordance with a preferred practice of the invention, a printed wiring board has a commutator at the rotation center on one side and a bearing at the rotation center on the other side. Disposed around the bearing are first, second and third wound coils, the effective conductors of which open as wide as the magnetic pole opening angle. A main component and supplementary part formed so as to be no thicker than the first wound coil are provided. An eccentric weight is disposed so that the main component does not protrude axially upward from the second and third wound air-core coils, and the second wound air-core coil and third wound air-core coil partially overlap both sides of the first wound air-core coil provided on the printed wiring board so that axial spaces are created outward of the first wound air-core coil, and the eccentric weight partly overlaps the second and third wound air-core coils when seen from a plan view so that the main component is on the side opposite the first wound air-core coil and the supplementary part is accommodated within the axial spaces.

### BRIEF DESCRIPTION OF THE DRAWINGS

FIG. 1 is a plan view of an eccentric rotor of a first embodiment of the present invention viewed from the commutator side;

FIG. 2 is a plan view of the eccentric rotor of FIG. 1 viewed from the coil side;

FIG. 3 is a vertical cross-sectional view of a flat vibration motor of the second embodiment of the present invention in which the eccentric rotor of FIG. 2 is accommodated in a state shown as the cross section along the line A-A;

FIG. 4 is a diagram for explaining operations of the motor of FIG. 3;

FIG. 5 is a plan view of the eccentric rotor of the third embodiment of the present invention viewed from the commutator side;

FIG. 6 is a plan view of the eccentric rotor of FIG. 5 viewed from the coil side;

FIG. 7 is a vertical cross-sectional view of the flat vibration motor of the fourth embodiment of the present invention in which the eccentric rotor of FIG. 6 is accommodated in a state shown as the cross section along the line B-B;

FIG. 8 is a diagram for explaining operations of the flat vibration motor of FIG. 7;

FIG. 9 is a plan view of the eccentric rotor of the fifth embodiment of the present invention viewed from the coil side;

FIG. 10 is a diagram for explaining operations of a flat vibration motor in which the eccentric rotor of FIG. 9 is used; and

FIG. 11 is a conventional cylindrical vibration motor.

### DETAILED DESCRIPTION OF THE PREFERRED EMBODIMENT

Referring now to FIGS. I and 2, reference numeral 1 denotes a printed wiring board with a thickness of about 0.1 mm having copper foil formed on both sides thereof, and formed in a disk shape when viewed in a plan view. The printed wiring board 1 has a through hole 1a at the center thereof, and on one side six commutator segment lands a, b, c, d, e and f plated with gold, forming a commutator SC. Opposing segments are connected via through holes S1, S2 provided in the printed wiring board 1.

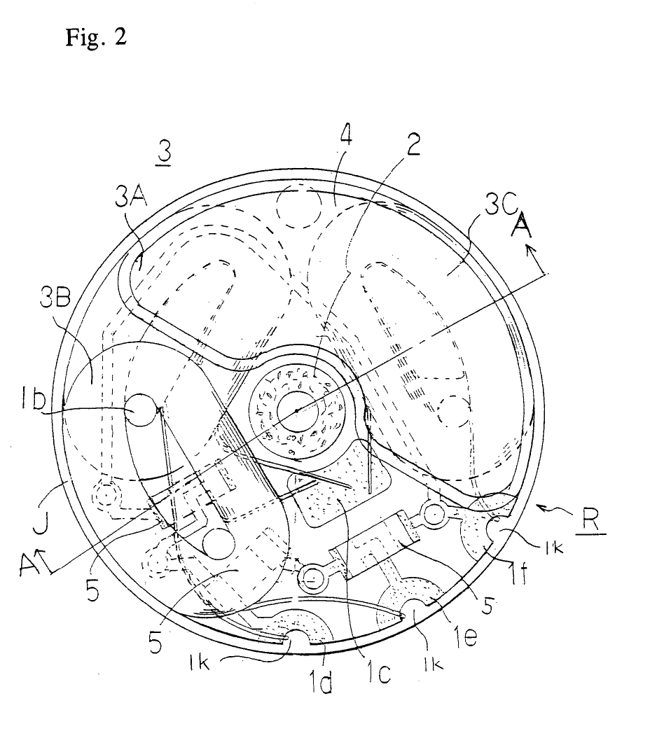

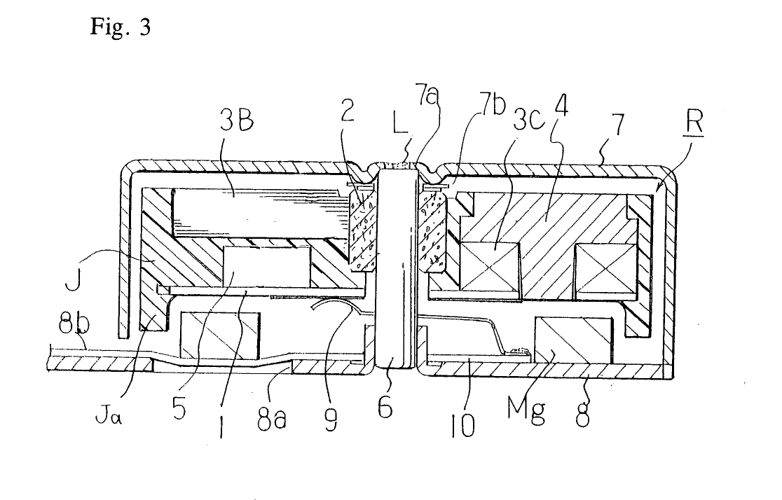

The printed wiring board 1 has, on the other side thereof, as shown in FIGS. 2 and 3, a bearing 2 provided in the center. An armature 3 is configured so that around the bearing 2, a first wound air-core coil 3A is disposed, as part of armature 3, using a guide hole 1b and the like, to be adhered and fixed to the printed wiring board 1. The first wound air-core coil 3A is configured so as to have an effective conductor with an opening angle of about 90° (equivalent to the magnetic pole opening angle). The effective conductor is a conductor portion of a coil radially extending from the rotation center of the eccentric rotor (i.e., the portion that is not a coil conductor portion extending in a circumferential direction), and generates torque in accordance with Fleming's left-hand rule in response to reception across an axial air-gap of an Mg magnetic field to be combined with the eccentric rotor.

On the first wound air-core coil 3A, a second wound air-core coil 3B (the same type as the first wound air-core coil in terms of production) adhered and fixed so as to overlap the first wound air-core coil 3A with an opening angle displaced 60° in the counterclockwise direction with respect to the first wound air-core coil 3A.

The third wound air-core coil 3C (same type as the first wound air-core coil 3A) with an opening angle displaced roughly 120° in the clockwise direction from the first wound air-core coil 3A is adhered and fixed to the printed wiring board 1 so as not to overlap with the wound air-core coils 3A, 3B.

The eccentric weight 4 is adhered and fixed to, and overlaps, the first wound air-core coil 3A and third wound air-core coil 3C, so as to bridge the same.

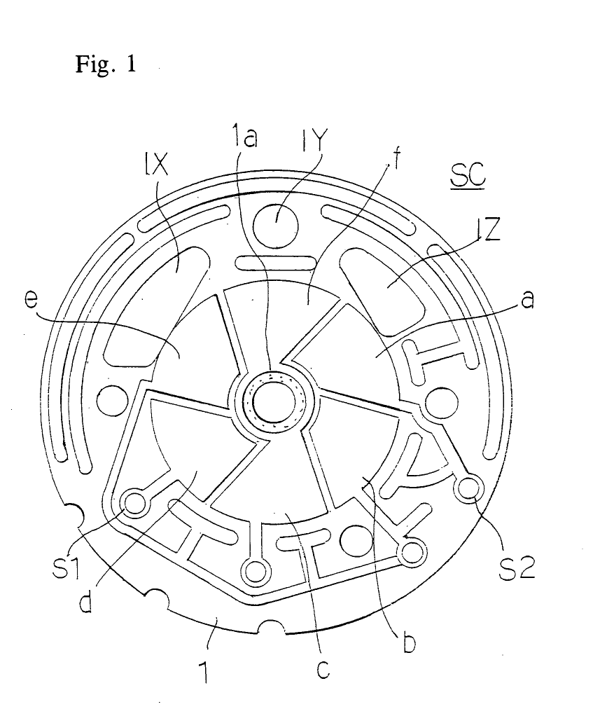

The eccentric weight 4 is made of tungsten, and disposed so as not to axially protrude above the surface of the second wiring wound air-core coil 3B as shown in FIG. 3. The eccentric weight 4 is attached in the attachment guide holes provided at 1X, 1Y and 1Z of FIG. 1.

Thus, because the second wound air-core coil 3B overlaps the first wound air-core coil 3A in a displaced manner, a space (dead space) is created between the second wound air-core coil 3B and printed wiring board 1. In the dead space, a spark quenching element 5, such as a chip capacitor, is partially disposed.

Therefore, with the spark quenching element 5 disposed in the dead space when seen from a plan view, accommodation efficiency is good and the occupancy rate of space for disposition improves. Further, with the thickness of the spark quenching element 5 set to be roughly equivalent to that of the first wound air-core coil 3A, the second wound air-core coil 3B achieves horizontality with the printed wiring board 1. The first wound air-core coil 3A and second wound air-core coil 3B are displaced at 60° because such space is available. Alternatively, the displacement can be set at as small as 30° depending on the size of the spark quenching element 5.

Next, on the other side of the printed wiring board 1, other than the surfaces on which the armature 3 and eccentric weight 4 are to be mounted, there are provided a connection land 1c for connecting one of the ends of the coils into one, and connection lands 1d, 1e and 1f for respectively connecting the other ends of the coils, each having a semicircular retainer notch 1k.

The wound air-core coil terminals are soldered and connected to the connection lands. The assembly component for the printed wiring board 1, armature 3 and eccentric weight 4 is integrally molded from a resin J (transparent here to enable confirm of interior configuration), formed in the eccentric rotor R in a circular shape. A ring-shaped bank part Ja is formed below lower periphery of the rotor R so as to vertically sandwich the periphery of the printed wiring board 1. With such a formation, even if slightly protruding from one side of the printed wiring board 1, the other end of the coils are buried within the ring-shaped bank part Ja, protecting such other end of the coils from disconnection. Further, the resin bank part Ja serves as a reinforcement to prevent the eccentric weight 4 and coils from coming off the printed wiring board 1 due to impact at time of a drop test.

With such a formation, the spark quenching element 5 is disposed in the space for disposition in dead space when seen in the plan view, the accommodation efficiency is good and the occupancy rate of the space is improved even when the eccentric rotor R has a small diameter.

In accordance with a second embodiment, the flat vibration motor comprising the eccentric rotor R shown in FIGS. 1 and 2 is a shaft fixed type as shown in FIG. 3. More specifically, the shaft 6 for rotatably supporting the eccentric rotor R has one end fitted in a shallow burring 7e of a case 7 constituting one of the housings. The shaft 6 is tightly fixed to the case 7 by laser welding L from the outside.

Onto other end of the shaft 6, the eccentric rotor R is fitted, and a bracket 8 constituting the other housing is fitted thereto. With such a constitution, axial movement of the flat vibration motor is suppressed. The opening of the case 7 and the periphery of the bracket 8 are firmly assembled by laser welding L at a number of places.

On the bracket 8, there is disposed a brush base 10 comprising a flexible substrate in which positive and negative brushes 9, 9 to come in sliding contact with the commutator SC are implanted at the base end.

On the bracket 8 on which the brush base 10 is disposed, a donut-shaped rare earth magnet Mg alternatingly magnetized N and S into four poles is adhered and fixed, and the magnet Mg and, across an axial gap, the eccentric rotor R are provided.

One end of the brush base 10 extends through a through hole 8a provided below the magnet Mg and serves as a power feed terminal 8b.

Reference numeral 7b of FIG. 3 denotes a sliding member comprising two polyester films intentionally given different outer diameters.

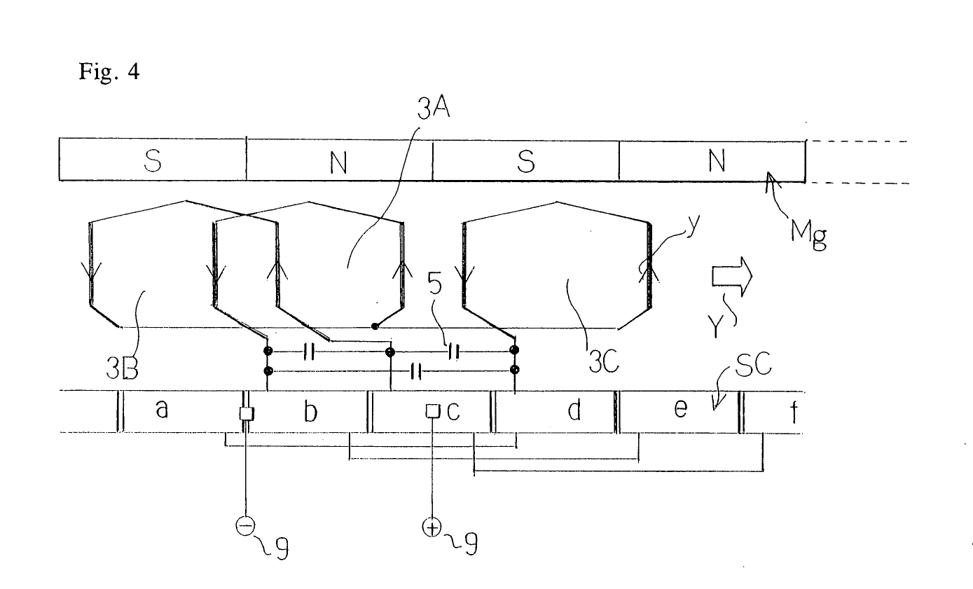

FIG. 4 is a diagram for explaining operations of the motor shown in FIG. 3. In FIG. 4, the opening angle of the pair of positive and negative brushes 9, 9 is equivalent to the magnetic pole opening angle, and the brushes to come in sliding contact with the commutator SC are positioned in the magnet neutral zone.

In FIG. 4, precisely when the negative brush 9 bridges the commutator segment a and commutator segment b and a current flows from the positive brush 9 via the commutator segment c, the current flows through all of the coils, and in the effective conductor, the current flows in the direction of the arrow y. Due to the current that flows through the effective conductor, torque is generated in the same direction as a magnetic pole of the Magnet Mg facing the coils, and no anti-torque is generated.

Further, because a spark quenching element 5 is disposed in the lower dead space, the disposition angle of the second wound air-core coil 3B is set at 60° in the counterclockwise direction from the wound air-core coil 3A. However, depending on the size of a spark quenching element, dead space for disposition of a spark quenching element is available even when the angle of coil displacement is reduced from 60° to 30°, and no anti-torque is generated.

With such a constitution, whichever position the eccentric rotor R stops at, at least two air-core coils will always generate torque, facilitating start. As a result, because an effective magnetic flux can be fully used, higher efficiency is achieved.

Next, in accordance with a third embodiment, a variation of the eccentric rotor of FIGS. 1 and 2 will be shown. Even if the shape is slightly different, members performing the same functions are assigned the same legends as above, and the explanation thereof is omitted.

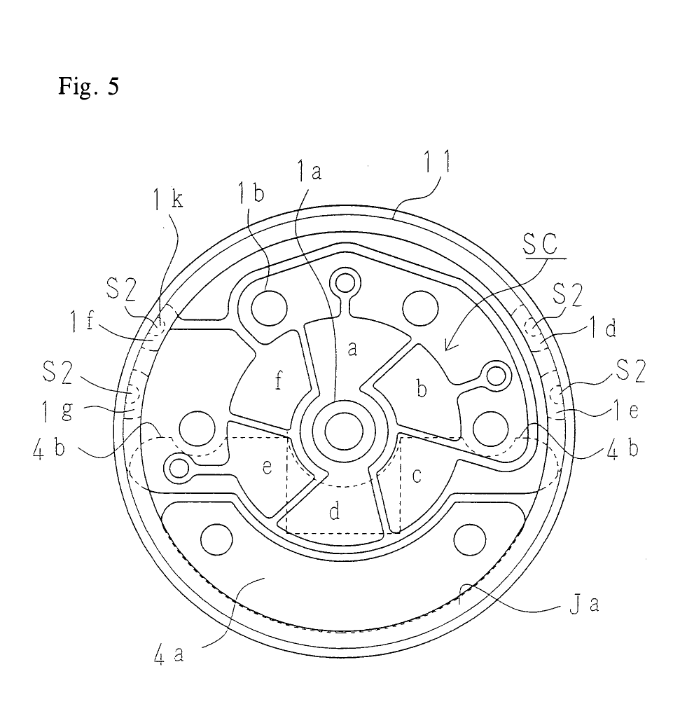

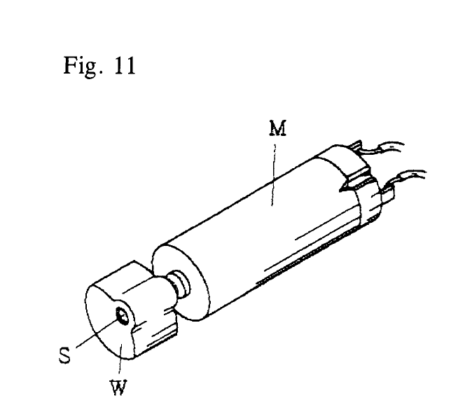

In FIGS. 5, 6 and 7, 11 is a printed wiring board with a thickness of about 0.1 mm, with copper foil formed on both sides. When seen from a plan view, the printed wiring board 11 has a substantially fan-shaped exterior shape, and comprises a shaft through hole 1 a at the center thereof. Further, the printed wiring board 11 has a commutator formed at the center on one side thereof, and on the center of the other side of the printed wiring board 11, a bearing 2. Radially outward of the bearing 2, the first wound air-core coil 3A is disposed as an armature, using the guide hole 1b etc. for adhesion and fixture to the printed wiring board 11. The wound air-core coil 3A has an effective conductor with an opening angle of about 90° (equivalent to the magnetic pole opening angle).

The second wound air-core coil 3B and third wound air-core coil 3C, which do not overlap each other, are both adhered and fixed to and overlap the upper surface of the wound air-core coil 3A. For purposes of ease of production, all wound air-core coils have the same specifications.

More specifically, because the disposition angle for the second and third wound air-core coils 3B, 3C is 120° of separation, and the effective conductor of the air-core coils is at 90°, the outer ends of either one of the second and third wound air-core coils 3B, 3C in the plan view is formed so as to slightly protrude in the radial direction of the rotor comprising no coil disposed therein.

With such a constitution, between the second and third wound air-core coils 3B, 3C and the printed wiring board 1, an axial space K is created.

The printed wiring board 11 comprises a connection land for connecting all the terminals and connection lands 1d, 1e and 1f, each having a retainer semicircular notch 1k respectively on the periphery. Prescribed terminals of the wound air-core coils are caught on the retainer semicircular notch 1k and soldered and connected, and by integral molding with a resin J (transparent here for confirmation of interior configuration) as the eccentric rotor R.

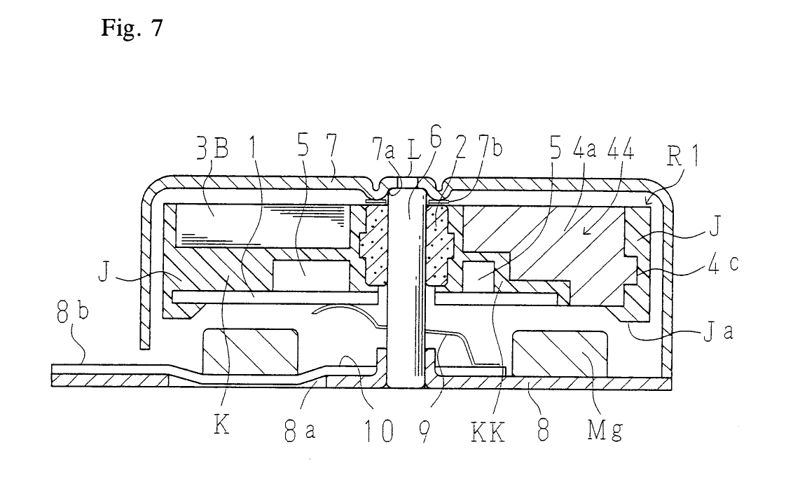

Here, too, with the ring-shaped bank part Ja disposed on the outer periphery, the end of the terminals can be protected even if slightly protruding on one side as shown in FIG. 7.

The resin bank part Ja serves as a reinforcement for the printed wiring board 11, eccentric weight 44, and coils.

The eccentric weight 44 is configured such that a main component 4a is disposed opposite the wound air-core coil, across the bearing 2, and a supplementary part 4b of the weight 44 no thicker than the first wound air-core coil 3A is formed on both sides. In the axial space K below the second and third wound air-core coil 3B, 3C, the supplementary part 4b is fitted along with the spark quenching element 5. Further, around the bearing 2 of the main component 4a of the eccentric weight 44, in the space between the eccentric weight 44 and the printed wiring board 11, there is a space KK in which a chip capacitor can be provided as a spark quenching element 5.

In such axial spaces K and KK, chip capacitors are disposed. Under the wiring coils 3B, 3C, a chip capacitor is implanted on the printed wiring board 11. Further, around the bearing 2 of the eccentric weight 44, a chip capacitor is implanted on the printed wiring board 11.

The printed wiring board 11 on which coils, eccentric weight 44 and chip capacitors are thus disposed is integrally molded with the resin J to configure an eccentric rotor R1.

With such a constitution, a portion of the surface area on which the spark quenching element 5 is to be disposed in the plan view can be ignored, so that the weight of the eccentric weight 44 can be substantially increased. Further, because the capacity ratio of the wiring coils is about 5, by forming the eccentric weight 44 from tungsten, a sufficient difference in specific gravity between the copper wire and tungsten can be achieved, thereby ensuring sufficient vibration.

Further, because the terminal connection lands 1d, 1e, 1f and 1g are formed at positions in the axial space K, high integration efficiency can be achieved by taking advantage of the dead space; therefore, there is no need to provide the lands on the eccentric weight, so that size of the eccentric weight is not sacrificed.

The device shown in FIG. 7, relating to a fourth embodiment, includes a flat vibration motor comprising such an eccentric rotor R1. While the members are identical to those of FIG. 3, there is a slight difference in the constitution of the eccentric weight 44, an explanation thereof will be given.

The main component 4a of the eccentric weight 44 is disposed so that a part of the main component 4a is disposed as an arc protrusion 4c, ensuring impact resistance at time of a drop test.

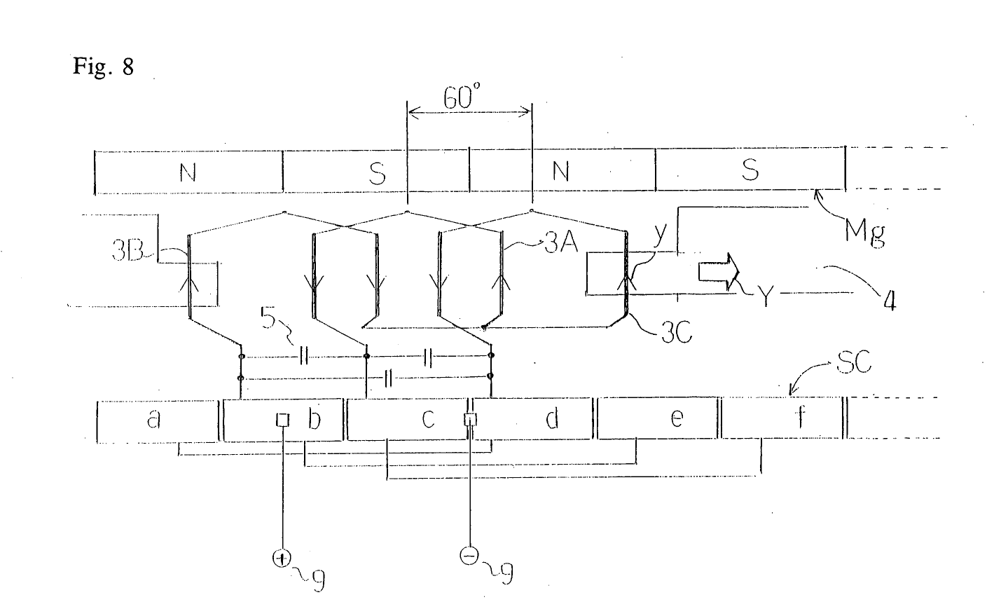

The diagram shown in FIG. 8 is to explain the operations of the flat vibration motor shown in FIG. 7. The commutator segment land and commutator segment (not shown in the drawings) are assigned the same legend as above when the positions are the same.

In FIG. 8 as well, precisely when the negative brush 9 bridges the commutator segment c and commutator segment d, and a current to be supplied from the positive brush 9 via the commutator segment b, the current flows through all the coils, and flows in the direction of the arrow y in the effective conductor. Due to the current that flows through the effective conductor, torque is generated in the same direction as the magnetic pole of the magnet Mg facing the coils, and rotational force is generated in the same direction y without producing anti-torque. When rotation has proceeded roughly 45°, the positive brush comes in contact with segment a and negative brush c comes in contact with the segment c. Thus, the effective conductor of the air core coil 3B is positioned in a neutral zone of the magnet Mg, and this is good because electricity is prevented from flowing through this air-core coil 3B and anti-torque is prevented. With such a constitution, two air-core coils always contribute to the rotational torque.

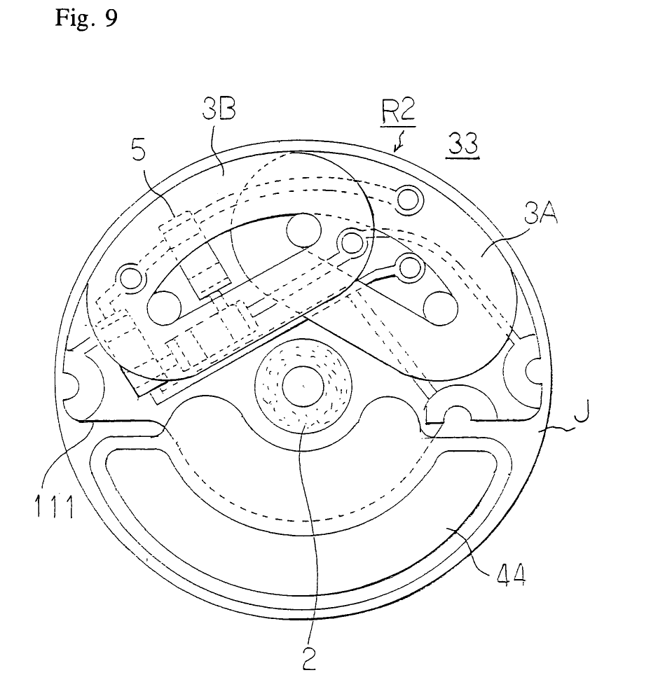

Next, in connection with a fifth embodiment, FIG. 9 shows another variation of the eccentric rotor of FIG. 2. Members identical to those described above are assigned the same legends and the explanation thereof is omitted.

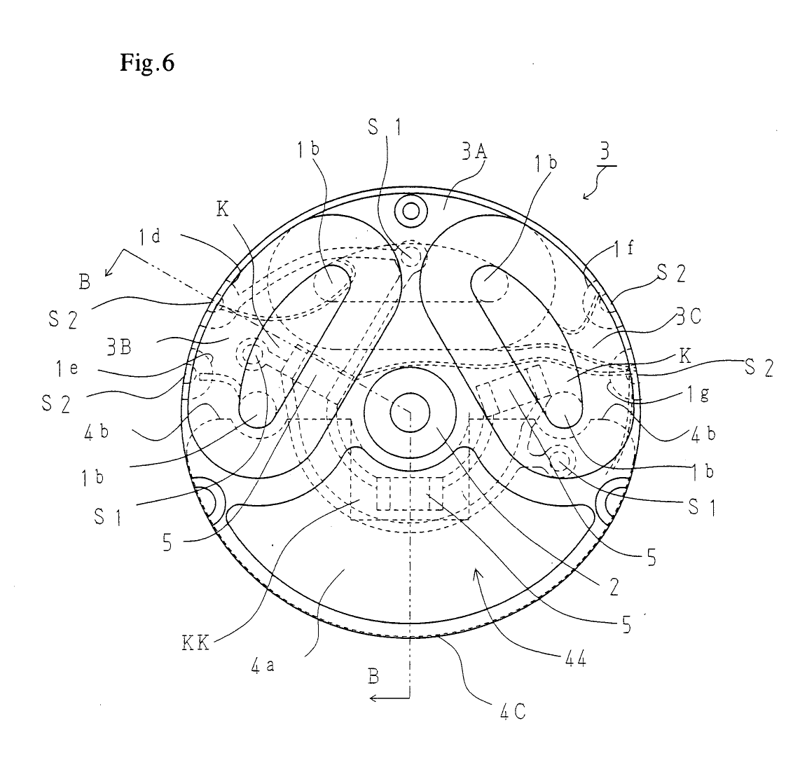

The eccentric rotor R2 comprises, as an armature 33 on the other side of the printed wiring board 111, only first and second wound air-core coils 3A, 3B displaced by 60° and overlapping each other. More specifically, the eccentric rotor R2 is such that the third wound air-core coil of FIG. 6 is omitted, so that the three coils are reduced in number to two, and the wiring terminals of the first and second coils are connected to each other.

The second air-core coil 3B is disposed above and displaced 60° from the first wound air-core coil 3A. In the space created between the second wound air-core coil 3B and printed wiring board 111, a spark quenching element 5 such as a chip capacitor is disposed.

For this reason, because the space for disposition of the spark quenching element 5 uses a space that is a dead space when seen from a plan view, the spark quenching element 5 can be mounted even in a small rotor. Only two armature coils overlapping each other are needed. As a result, the eccentric weight 44 disposed on the opposite side across the bearing 2 can be increased in size, achieving a large vibration even with a small size.

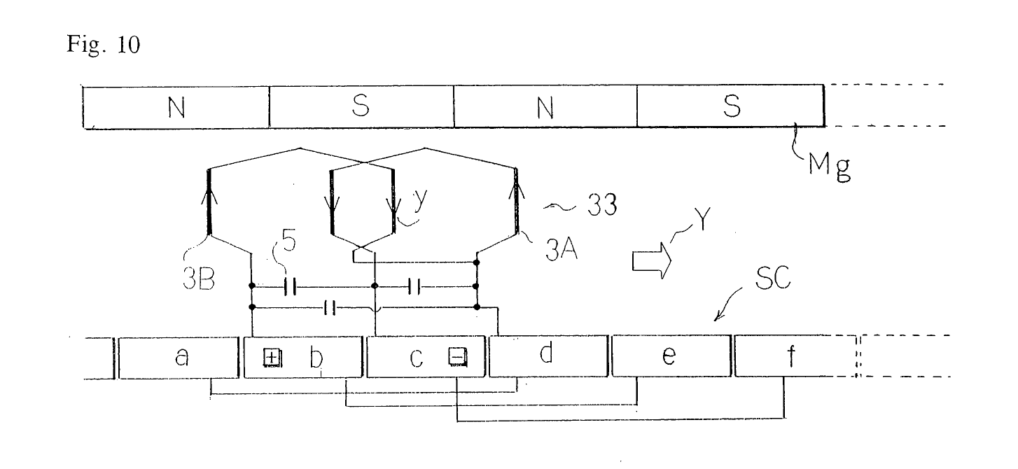

FIG. 10 is a drawing to explain operations of a motor using the eccentric rotor R2 shown in FIG. 9. Since the members are identical to those described above, explanation thereof is omitted.

In the above embodiments, a commutator is configured as a flat plate type in which a commutator segment of a printed wiring board is plated with gold, and an axial sliding contact brush is used. If the thickness allows, in an alternative constitution, the commutator is formed as a cylinder, and the brush is a radial sliding contact type.

The present invention can be implemented in a variety of ways, without departing from this technical concept and features inherent thereto. Therefore, the above-described embodiments are merely illustrative examples and should not be construed as limiting.

The technical scope of the present invention is described by the claims and is not restricted to the text of the description.

What is claimed is:

1. An eccentric rotor, comprising:
a printed wiring board having a commutator disposed at a rotation center thereof on one side and a bearing at the rotation center on an other side;
at least first and second wound air-core coils disposed around the bearing and having an effective conductor opened as wide as a magnetic pole opening angle; and
an eccentric weight being disposed at a position which does not overlap the second wound air-core coil, so that the main component does not protrude axially upward of the second axial air-core coil, wherein:
the first wound air-core coil is implanted on the printed wiring board, and the second wound air-core coil is provided on the first wound air-core coil so as to be displaced therefrom and partly overlapping the same thereon; and
at least some of other members constituting the rotor that are thinner than the first wound air-core coil are accommodated in an axial space outward of the first wound air-core coil created by the above displacing and overlapping.

2. An eccentric rotor according to claim 1, wherein said at least some of the other members include a chip-type spark quenching element.

3. An eccentric rotor according to claim 1, wherein said at least some of the other members include a supplementary portion of the eccentric weight.

4. An eccentric rotor according to claim 2, further comprising a third wound coil, said second wound air-core coil being disposed on the first wound air-core coil so that a disposition angle of said second wound air-core coil is displaced about 60° from the first wound air-core coil, and the third wound air-core coil being disposed so as not to overlap the first and second wound air-core coils.

5. A flat vibration motor, comprising:
an eccentric rotor, including:
a printed wiring board having a commutator disposed at a rotation center thereof on one side and a bearing at the rotation center on an other side,
at least first and second wound air-core coils disposed around the bearing and having an effective conductor opened as wide as a magnetic pole opening angle, and
an eccentric weight being disposed at a position which does not overlap the second wound air-core coil, so that the main component does not protrude axially upward of the second axial air-core coil,
the first wound air-core coil being implanted on the printed wiring board, and the second wound air-core coil is provided on the first wound air-core coil so as to be displaced therefrom and partly overlapping the same thereon, and
at least some of other members constituting the rotor that are thinner than the first wound air-core coil being accommodated in an axial space outward of the first wound air-core coil created by the above displacing and overlapping;
a shaft for supporting the eccentric rotor;
a magnet for supplying magnetic field to this rotor across an axial gap;
brushes for supplying power to the air-core coils via the commutator; and
housings accommodating the eccentric motor, the shaft, the magnet and the brushes, the shaft being fixed to one of the housings so as not to outwardly protrude, and the eccentric rotor, after attachment, being received by an other of the housing, preventing radial movement.

6. An eccentric rotor, comprising:
a printed wiring board on which a commutator is disposed at the rotation center on one side and a bearing is disposed at the rotation center on the other side;
first, second and third wound air-core coils disposed around the bearing and having an effective conductor opened as wide as the magnetic pole opening angle;
an eccentric weight having a main component and a supplementary part formed so as to be no thicker than the first wound air-core coil and disposed so that the main component does not protrude axially upward of the second and third axial air-core coils;
wherein:
the wound air-core coils are constituted so that the second wound air-core coil and third wound air-core coil partially overlap both sides of the first wound air-core coil implanted on the printed wiring board, thereby creating an axial space outward of both sides of the first wound air-core coil; and
the eccentric weight is constituted so that the main component is provided opposite the first wound air-core coil across the bearing, and the supplementary part is accommodated in the axial space so as to overlap the second and third wound air-core coils when seen in a plan view.

7. An eccentric rotor according to claim 6, wherein a chip-type spark quenching element is at least partly accommodated in a part of the axial space.

8. An eccentric rotor according to claim 7, wherein a part of the spark quenching element is disposed on the main component side of the eccentric weight and overlaps a part of the main component.

9. An eccentric rotor according to claim 6, wherein:
connection lands are formed around the periphery on one side of the printed wiring board; and
the terminals of the wound air-core coils are connected to the connection lands, and covered with a resin bank part.

10. An eccentric rotor according to claim 9, wherein at least a part of the connection lands is formed in the axial space.

11. A flat vibration motor, comprising:
an eccentric rotor, including:
a printed wiring board on which a commutator is disposed at the rotation center on one side and a bearing is disposed at the rotation center on the other side;
first, second and third wound air-core coils disposed around the bearing and having an effective conductor opened as wide as the magnetic pole opening angle;
an eccentric weight having a main component and a supplementary part formed so as to be no thicker than the first wound air-core coil and disposed so that the main component does not protrude axially upward of the second and third axial air-core coils;
the wound air-core coils being constituted so that the second wound air-core coil and third wound air-core coil partially overlap both sides of the first wound air-core coil implanted on the printed wiring board, thereby creating an axial space outward of both sides of the first wound air-core coil; and
the eccentric weight being constituted so that the main component is provided opposite the first wound air-core coil across the bearing, and the supplementary part is accommodated in the axial space so as to overlap the second and third wound air-core coils when seen in a plan view;
a shaft for supporting the eccentric rotor;
a magnet for supplying magnetic force to the rotor across an axial air gap; brushes for supplying power to the air-core coils via the commutator; and
housings accommodating the foregoing, the shaft being fixed on one of the housings so as not to outwardly protrude, and the attached eccentric rotor being received by an other of the housings, preventing radial movement thereof.
